(19) United States
(12) Patent Application Publication
(10) Pub. No.: US 2012/0051429 A1
(43) Pub. Date: Mar. 1, 2012

(54) APPARATUS FOR GENERATING INTERPOLATED FRAME

(75) Inventors: Sang Ki Kim, Uiwang (KR); Suk Young Roh, Anyang (KR); Don Hyoung Lee, Anyang (KR); Jeong Hwan Hwang, Suwon (KR); Jung-Yang Bae, Seoul (KR)

(73) Assignees: HYUNDAI MOTOR COMPANY, Seoul (KR); C&S TECHNOLOGY CO., LTD., Seoul (KR); KIA MOTORS CORPORATION, Seoul (KR)

(21) Appl. No.: 12/957,934

(22) Filed: Dec. 1, 2010

(30) Foreign Application Priority Data
Aug. 27, 2010 (KR) 10-2010-0083436

(51) Int. Cl. H04N 7/12

(52) U.S. Cl. 375/240.16; 375/E07.027

(57) ABSTRACT

Provided is a system for generating an interpolated frame, which includes an image decoding module configured to decode a first frame from an original image information, the first frame being divided into unit images, and an interpolated frame generating module configured to extract a motion information of each of the unit images between the first frame and the second frame, the motion information being written in a second frame of the original image information, and generate the interpolated frame that is to be inserted between the first frame and the second frame by using the first frame and the motion information of each of the unit images.

### CROSS-REFERENCES TO RELATED APPLICATIONS

This application claims under 35 U.S.C. §119(a) the benefit of Korean Patent Application No. 10-2010-0083436, filed on Aug. 27, 2010, which is incorporated by reference in its entirety.

### BACKGROUND OF THE INVENTION

1. Field of the Invention

The present invention relates to a system for generating an interpolated frame, which produces an image having an increased number of frames compared to that of original frames by generating and inserting motion-compensated interpolated frames between the original frames.

2. Description of the Related Art

An interpolated frame generating system generates and inserts a motion-compensated interpolated frame between original frames to produce an image so as to improve display quality of a display device. For example, the interpolated frame generating system may generate an image that presents 15 original frames per second of original image information and 15 interpolated frames per second that are inserted between the original frames, i.e., 30 frames per second.

FIG. 1 is a schematic diagram illustrating a method of generating an interpolated frame by using a conventional interpolated frame generating system.

As illustrated in FIG. 1, the conventional interpolated frame generating system decodes the first frame and the second frame from the original image information and extracts the decoded first frame and motion information of an unit image in the second frame (for example, 16×16 pixel). In other words, in the conventional interpolated frame generating system, a location of a specific unit image in the first frame is compared with that in the second frame to extract a travel distance of the specific unit image between the first frame and the second frame. Then, the conventional interpolated frame generating system generates an interpolated frame in which the specific unit image is moved by a distance corresponding to one half (½) of the extracted travel distance. The conventional interpolated frame generating system reconfigures an image by inserting the interpolated frame between the first frame and the second frame.

According to the conventional interpolated frame generating system, an image may have a smoother and more natural motion by inserting the interpolated frame between the original frames; however, the conventional interpolated frame generating system has the following disadvantages.

In order to insert the interpolation frame between the first frame and the second frame, the conventional interpolated frame generating system decodes both the first frame and the second frame. Namely, the conventional interpolated frame generating system first decodes the first frame and the second frame from the original image information and generates the interpolated frame that is to be inserted between the first frame and the second frame. The conventional interpolated frame generating system then inserts the interpolated frame between the first frame and the second frame to produce the image. Therefore, it is impossible in the conventional interpolated frame generating system to create the interpolated frame, which is to be reproduced before the second frame. Namely, in the conventional interpolated frame generating system, the interpolated frame which is reproduced before the second frame is created after the second frame is decoded. Therefore, the conventional interpolated frame generating system needs to decode the second frame, generate the interpolated frame, and reproduce in an order of the first frame—the interpolated frame—the second frame. Accordingly, in the conventional interpolated frame generating system, there is a disparity between an order in which frames are decoded and the interpolated frame is generated and an order in which the frames are reproduced so that a delay time in outputting an image of the second frame may occur.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in view of the above problems, and provides a system for generating an interpolated frame in which an order of decoding frames and generating the interpolated frame coincides with an order of reproducing frames, thereby preventing a delay time in reproducing a specific frame due to interpolated frame generation.

According to an aspect of the present invention, a system for generating an interpolated frame includes an image decoding module configured to decode a first frame from original image information, the first frame being divided into unit images; and an interpolated frame generating module configured to extract motion information of each of the unit images between the first frame and the second frame, the motion information being written in a second frame of the original image information, and generate the interpolated frame that is to be inserted between the first frame and the second frame by using the first frame and the motion information of each of the unit images.

The interpolated frame generating module may include a location information identifying unit configured to identify location information of each of the unit images in the first frame; a motion information identifying unit configured to extract, from the second frame, the motion information of each of the unit images between the first frame and the second frame; an image extraction unit configured to extract, from the first frame, an image of each of the unit images by using the location information of each of the unit images; and a generating unit configured to generate the interpolated frame by modifying the location information of each of the unit images according to the motion information.

The generating unit may generate the interpolated frame by modifying the location information of each of the unit images by a distance corresponding to one half (½) of the motion information.

The system for generating the interpolated frame may further include an image reproducing module configured to output the first frame and the interpolated frame; and a database configured to temporarily store the first frame and the interpolated frame.

The image reproducing module may reproduce the first frame or the interpolated frame whenever the first frame or the interpolated frame is temporarily stored in the database, or subsequently reproducing the first frame and the interpolated frame when both the first frame and the interpolated frame are temporarily stored in the database.

Compared to a conventional technique to generate the interpolated frame between the first frame and the second frame by extracting both the first frame and the second frame from the original image information and comparing unit images of the extracted first frame and the extracted second frame, in the present invention, only the first frame is extracted from the original image information and the motion information of each of the unit images between the first frame and the second frame is extracted from the second frame to generate the interpolated frame by using the extracted motion information and the first frame. Therefore, compared to the conventional technique in which the first frame is extracted, the second frame is extracted, the interpolated frame is generated and inserted between the first frame and the second frame, and the frames are reproduced in an order of the first frame, the interpolated frame and the second frame, which causes a delay in reproduction of the second frame, in the present invention, the first frame is extracted and reproduced, the interpolated frame between the first frame and the second frame is generated and reproduced, and the second frame is extracted and reproduced without a delay. Thus, compared to the conventional technique where the interpolated frame between the first frame and the second frame is generated later than the second frame, which causes a delay in reproduction of the second frame, the present invention may prevent such delay in reproduction of the second frame.

In addition, in the present invention, not all of the first frame, the interpolated frame and the second frame are stored in the database but only the first frame and the interpolated frame need to be stored. Therefore, according to the present invention, a memory usage can be reduced. Also, according to the present invention, frames can be extracted (or generated) and reproduced in an order of the first frame, the interpolated frame inserted between the first frame and the second frame and the second frame. Thus, according to the present invention, frames do not need to include information of an output order (or output time) thereof. Further, the present invention obviates a need for an element for comparing and analyzing the travel information of the image unit between the first frame and the second frame. Therefore, the interpolated frame generating system according to the present invention may have a simplified configuration, thereby reducing a manufacturing cost.

### BRIEF DESCRIPTION OF THE DRAWINGS

The objects, features and advantages of the present invention will be more apparent from the following detailed description in conjunction with the accompanying drawings, in which:

FIG. 1 is a schematic diagram illustrating a method of generating an interpolated frame by using a conventional interpolated frame generating system;

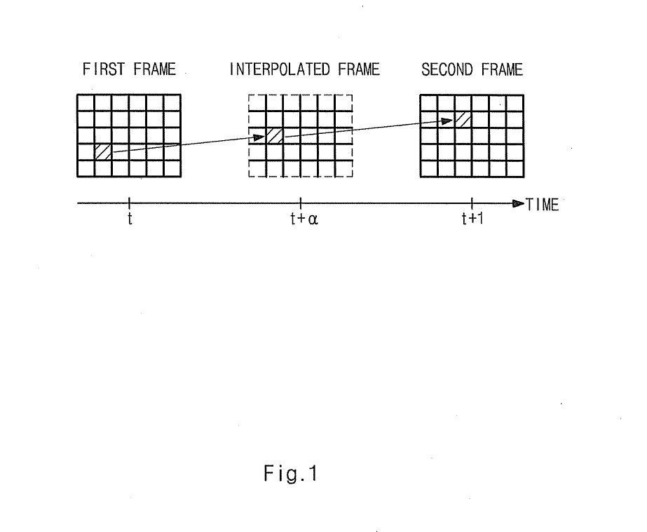

FIG. 2 is a block diagram illustrating a system for generating an interpolated frame according to an embodiment of the present invention;

FIG. 3 is a block diagram illustrating an interpolated frame generating module according to an embodiment of the present invention;

FIG. 4 is a schematic diagram illustrating an example of generating an interpolated frame by an interpolated frame generating module according to an embodiment of the present invention; and

FIG. 5 is a flowchart illustrating an example of the operation of a system for generating an interpolated frame according to an embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

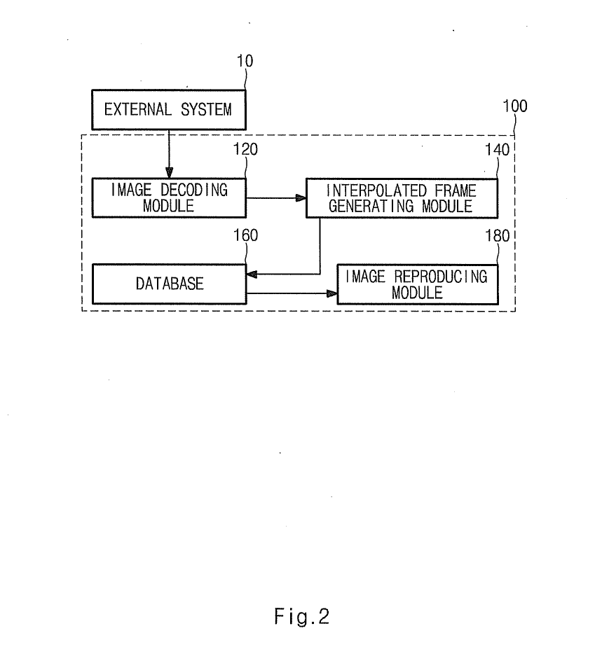

FIG. 2 is a block diagram illustrating a system for generating an interpolated frame according to an embodiment of the present invention.

As illustrated in FIG. 2, an interpolated frame generating system 100 according to an embodiment of the present invention may include an image decoding module 120, an interpolated frame generating module 140, a database 160, and an image reproducing module 180.

The image decoding module 120 receives original image information from an external system 10 such as, for example, a video streaming server or a content providing terminal. The image decoding module 120 decodes and extracts from the original image information a first frame which is divided into unit images by using a general decoding algorithm, and temporarily stores the decoded first frame in the database 160.

The interpolated frame generating module 140 does not decode or extract a second frame of the original image information but extracts only motion information of each of the unit images between the first frame and the second frame, which is included in the second frame of the original image information. From the first frame that is temporarily stored in the database 160 and the motion information of each of the unit images, the interpolated frame generating module 140 generates an interpolated frame that is to be inserted between the first frame and the second frame, and temporarily stores the generated interpolated frame in the database 160.

The database 160 temporarily stores the first frame extracted by the image decoding module 120 and the interpolated frame generated by the interpolated frame generating module 140.

The image reproducing module 180 reproduces the first frame and the interpolated frame that are temporarily stored in the database 160.

Each component of the interpolated frame generating system 100 according to the present invention will be described in detail below.

Image Decoding Module 120

As illustrated in FIG. 2, the image decoding module 120 receives from an external system 10, for example, a video streaming server or a content providing terminal original image information for which an interpolated frame is to be generated. The image decoding module 120 decodes and extracts a first frame from the original image information by using a general decoding algorithm. Then the image decoding module 120 stores the extracted first frame in the database 160, which will be further described below. Here, the first frame typically comprises unit images (macroblock), for example, a 16×16 pixel block or 8×8 pixel block. Location information of each of the unit images, for example, coordinate information (x, y) is written in a header of the first frame.

Interpolated Frame Generating Module 140

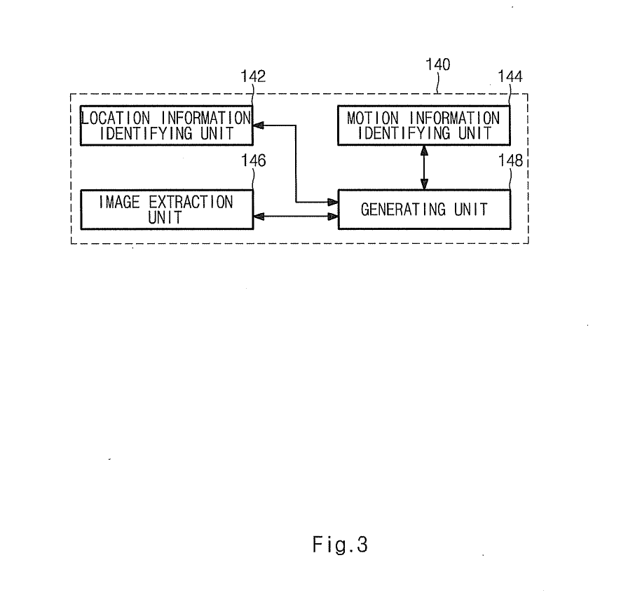

FIG. 3 is a block diagram illustrating the interpolated frame generating module according to the present invention.

As illustrated in FIGS. 2 and 3, the interpolated frame generating module 140 includes a location information unit 142, a motion information identifying unit 144, an image extraction unit 146, and a generating unit 148.

The location information identifying unit 142 identifies the location information (x, y) of each of the unit images of the first frame by using the header of the first frame

The motion information identifying unit 144 extracts the motion information of each of the unit images between the first frame and the second frame, which is written in a header of the second frame of the original image information. Here, the second frame of the original image information includes travel distance information of each of the unit images with respect to a previous frame, i.e., the first frame, wherein the travel distance information of each of the unit images indicates how far a specific unit image in the second frame has moved from a position in the first frame along X and Y axes. The generating unit 148, which will be further described below, identifies how far the specific unit image of the first frame has moved to a certain location in the second frame by using the motion information. Here, the motion information of each of the unit images between the first frame and the second frame, which is included in the second frame, is encoded and written by the external system 10 such as, for example, the video streaming server or the content providing terminal that produces the original image information. Techniques to encode such motion information is known to those skilled in the art, and thus a detailed description thereof will be omitted.

The image extraction unit 146 extracts an image of each of the unit images from the first frame by using the motion information of each of the unit images.

The generating unit 148 generates the interpolated frame to be inserted between the first frame and the second frame by adding, for example, ½ of the travel distance information included in the motion information of each of the unit images detected by the motion information identifying unit 144 to the location information of each of the unit images of the first frame detected by the location information identifying unit 142.

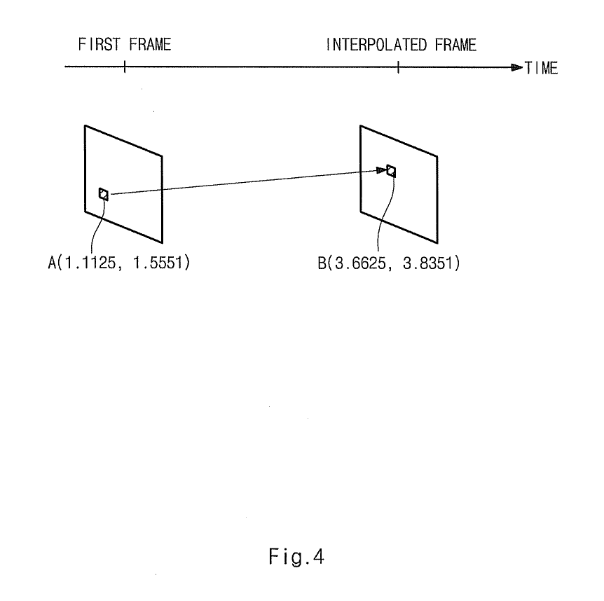

FIG. 4 is a schematic diagram illustrating an example of generating an interpolated frame by the interpolated frame generating module according to the present invention.

As illustrated in FIGS. 3 and 4, it is assumed that the location information of a specific unit image (A) of the first frame is, for example, (1.1125, 1.5551), and the motion information of the specific unit image of the first frame is identified to be (5.10, 4.56). In this case, the generating unit 148 adds one half of the motion information, i.e., (2.55, 2.28), to the location information of the specific unit image of the first frame, thereby changing the location information of the specific unit image of the first frame to (3.6625, 3.8351). Next, the generating unit 148 inserts an image corresponding to the specific unit image, which is extracted by the image extraction unit 146, into a location corresponding to the location information (3.6625, 3.8351) in the interpolated frame to produce a new interpolated frame that includes a specific unit image (B) having modified location information. Next, the generating unit 148 temporarily stores the generated interpolated frame in the database 160, which will be further described below. Thus, the location of the specific image in the interpolated frame becomes a middle point between a position in the first frame and a position in the second frame because of addition of one half (½) of the motion information. The interpolated frame is inserted between the first frame and the second frame so that the image reproducing module 180, which will be further described below, can produce an image having a more natural and smoother movement.

Database 160 and Image Reproducing Module 180

As illustrated in FIG. 2, the first frame and the interpolated frame are temporarily stored in the database 160.

The image reproducing module 180 reproduces the first frame and the interpolated frame that are temporarily stored in the database 160. Here, the image reproducing module 180 may reproduce the first frame immediately when the first frame is temporarily stored in the database 160 and reproduce the interpolated frame immediately when the interpolated frame is temporarily stored in the database 160. Alternatively, the image reproducing module 180 may subsequently reproduce the first frame and the interpolated frame when both of the first frame and the interpolated frame are stored in the database 160.

The operation of the interpolated frame generating system 100 according to the present invention is described below.

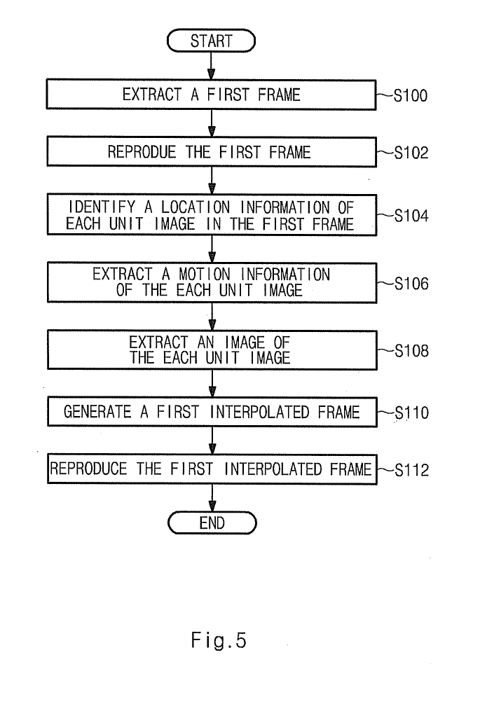

FIG. 5 is a flowchart illustrating an example of the operation of a system for generating an interpolated frame according to the present invention.

As illustrated in FIGS. 2, 3 and 5, the image decoding module 120 of the interpolated frame generating system 100 receives the original image information from the external system 10, decodes and extracts the first frame from the received original image information and temporarily stores the extracted first frame in the database 160 (S100).

Next, the image reproducing module 180 reproduces the first frame that is temporarily stored in the database 160 (S102).

Next, the location information identifying unit 142 of the interpolated frame generating module 140 identifies, from the first frame that is temporarily stored in the data base 160, the location information of each of unit images of the first frame (S104).

Next, the motion information identifying unit 144 of the interpolated frame generating module 140 extracts the motion information of each of the unit images between the first frame and the second frame from a header of the second frame of the original image information (S106).

Next, the image extraction unit 146 of the interpolated frame generating module 140 extracts an image of each of the from the first frame by using the location information of each of the unit images (S108).

Next, the generating unit 148 generates a first interpolated frame produced by moving the location information of the image of each of the unit images identified based on the location information according to the motion information and temporarily stores the first interpolated frame in the database 160 (S110).

Next, the image reproducing module 180 reproduces the first interpolated frame temporarily stored in the database 160 (S112).

Next, the image decoding module 120 decodes the second frame and the interpolated frame generating module 140 extracts the motion information of each of the unit images between the second frame and a third frame, which is written in the third frame of the original image information. The interpolated frame generating module 140 generates a second interpolated frame to be inserted between the second frame and the third frame by using the motion information of each of the unit images between the second frame and the third frame. In the same way, the first frame through an M-th interpolated frame can be successively produced and inserted between the first frame through an N-th frame.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A system for generating an interpolated frame, the system comprising:
an image decoding module configured to decode a first frame from original image information, the first frame being divided into unit images; and
an interpolated frame generating module configured to extract motion information of each of the unit images between the first frame and the second frame, the motion information being written in a second frame of the original image information, and generate the interpolated frame that is to be inserted between the first frame and the second frame by using the first frame and the motion information of each of the unit images.

2. The system according to claim 1, wherein the interpolated frame generating module includes,
a location information identifying unit configured to identify location information of each of the unit images in the first frame;
a motion information identifying unit configured to extract from the second frame the motion information of each of the unit images between the first frame and the second frame;
an image extraction unit configured to extract from the first frame an image of each of the unit images by using the location information of each of the unit images; and
a generating unit configured to generate the interpolated frame by modifying the location information of each of the unit images according to the motion information.

3. The system according to claim 2, wherein the generating unit generates the interpolated frame by modifying the location information of each of the unit images by a distance corresponding to one half (½) of the motion information.

4. The system according to claim 1, further comprising:
an image reproducing module configured to output the first frame and the interpolated frame; and
a database configured to temporarily store the first frame and the interpolated frame.

5. The system according to claim 4, wherein the image reproducing module reproduces the first frame or the interpolated frame whenever the first frame or the interpolated frame is temporarily stored in the database, or sequentially reproduces the first frame and the interpolated frame when both the first frame and the interpolated frame are temporarily stored in the database.
